(19) United States
(12) Patent Application Publication
(10) Pub. No.: US 2025/0348096 A1
(43) Pub. Date: Nov. 13, 2025

(54) INTEGRATED CIRCUIT FOR CONVERTING VOLTAGE AND POWER MANAGEMENT INTEGRATED CIRCUIT INCLUDING THE SAME

(71) Applicant: SAMSUNG ELECTRONICS CO., LTD., SUWON-SI (KR)

(72) Inventors: Jaeseung LEE, Suwon-si (KR); Sungwan HONG, Seoul-si (KR); Hyojin PARK, Seoul-si (KR); Junhyeok YANG, Suwon-si (KR); Sungmin YOO, Suwon-si (KR)

(73) Assignee: Sogang University Research Foundation, Seoul (KR)

(21) Appl. No.: 19/004,594

(22) Filed: Dec. 30, 2024

(30) Foreign Application Priority Data
May 9, 2024 (KR) 10-2024-0061337

(51) Int. Cl. G05F 1/56

(52) U.S. Cl. CPC G05F 1/56

(57) ABSTRACT

An integrated circuit including: an input node configured to receive an input voltage; a first switch, a second switch, and a third switch sequentially connected in series between the input node and a ground terminal; a fourth switch, a fifth switch, and a sixth switch sequentially connected in series between the input node and the ground terminal; a capacitor including a first end connected to the first switch and the second switch, and a second end connected to the fifth switch and the sixth switch; a first inductor including a first end connected to the fourth switch and the fifth switch, and a second end connected to an output node; a second inductor including a first end connected to the second switch and the third switch, and a second end connected to the output node; and a controller configured to control the first switch through the sixth switch.

### CROSS-REFERENCE TO RELATED APPLICATION

This application claims priority under 35 U.S.C. § 119 to Korean Patent Application No. 10-2024-0061337, filed on May 9, 2024, in the Korean Intellectual Property office, the disclosure of which is incorporated by reference herein in its entirety.

### Technical Field

The inventive concept is related to an integrated circuit and a power management integrated circuit including the integrated circuit, and more particularly, to an integrated circuit for converting voltage and a power management integrated circuit including the same.

### Discussion of Related Art

As electronic devices become smaller and their components take on more functions with the development of technology, there is an increasing need for efficient and stable power supply solutions for these components.

A converter may be used to generate a supply voltage to power to various electronic components, referred to as the load, which operates by consuming the load current provided by the converter. The load may require various supply voltages, leading to variations in the voltage conversion ratio, i.e., the ratio of the converter's input voltage to the supply voltage delivered to the load. Therefore, it is necessary to stably supply power across a wide range of voltage conversion ratios while simultaneously minimizing power loss during the supply process.

### SUMMARY

The inventive concept provides an integrated circuit for supporting an efficient and stable power supply and a power management integrated circuit including the same.

According to an embodiment of the inventive concept, there is provided an integrated circuit including: an input node configured to receive an input voltage; a first switch, a second switch, and a third switch sequentially connected in series between the input node and a ground terminal; a fourth switch, a fifth switch, and a sixth switch sequentially connected in series between the input node and the ground terminal; a capacitor including a first end connected to the first switch and the second switch, and a second end connected to the fifth switch and the sixth switch; a first inductor including a first end connected to the fourth switch and the fifth switch, and a second end connected to an output node; a second inductor including a first end connected to the second switch and the third switch, and a second end connected to the output node; and a controller configured to control the first switch through the sixth switch.

According to an embodiment of the inventive concept, there is provided an integrated circuit including: an input node configured to receive an input voltage; a first inductor and a second inductor; a capacitor including a first end connected to the first inductor and a ground terminal via at least one switch, and including a second end connected to the second inductor and the input node via at least one switch; a plurality of switches configured to set connections between the input node, the ground terminal, the first inductor, the second inductor, and the capacitor based on an operation mode; an output node connected to the first inductor and the second inductor, and configured to provide an output voltage to a load; and a controller configured to control the plurality of switches.

According to an embodiment of the inventive concept, there is provided a method of controlling an integrated circuit, wherein the integrated circuit includes: an input node configured to receive an input voltage; a capacitor including a first end connected to a first inductor and a ground terminal via a switch, the capacitor including a second end connected to a second inductor and the input node via a switch; a plurality of switches configured to set connections between the input node, the ground terminal, the first inductor, the second inductor, and the capacitor; and an output node connected to the first inductor and the second inductor, the output node configured to provide an output voltage to a load, and wherein the method includes: determining an operation mode based on the output voltage and the input voltage; and controlling the plurality of switches according to the operation mode.

### BRIEF DESCRIPTION OF THE DRAWINGS

Embodiments of the inventive concept will be more clearly understood from the following detailed description taken in conjunction with the accompanying drawings in which:

FIG. 1 is a schematic block diagram of a system according to an embodiment;

FIG. 2 is a circuit diagram of a converter according to an embodiment;

FIG. 3 is a flowchart of an operation of a converter based on an operation mode according to an embodiment;

FIGS. 4A and 4B are circuit diagrams of a charging phase and a discharging phase of a capacitor, respectively, according to embodiments;

FIG. 5 is a circuit diagram of a current discharging phase of an inductor, according to an embodiment;

FIG. 6 is a graph of a waveform of an inductor current in an operation mode, according to an embodiment;

FIGS. 7A and 7B are circuit diagrams of a charging phase and a discharging phase of a capacitor, respectively, according to embodiments;

FIG. 8 is a circuit diagram of a current storing phase of an inductor, according to an embodiment;

FIGS. 9 and 10 are graphs of waveforms of an inductor current in an operation mode, according to embodiments;

FIG. 11 is a flowchart of an operation of a converter based on an operation mode, according to an embodiment;

FIGS. 12 and 13 are graphs of waveforms of inductor currents in an operation mode, according to embodiments;

FIGS. 14A and 14B are diagrams illustrating a controller and its operation, respectively, according to embodiments; and

FIG. 15 is a system including an integrated circuit according to an embodiment.

### DETAILED DESCRIPTION OF THE EMBODIMENTS

Hereinafter, embodiments of the inventive concept are described in detail with reference to the accompanying drawings.

Terms, such as ‘first’ and ‘second’, used in the inventive concept are used to differentiate between components and do not imply any specify structure or connection relationship. In other words, the configuration of the integrated circuit is not limited to the embodiments described and may be implemented in various ways to achieve the structure of the inventive concept.

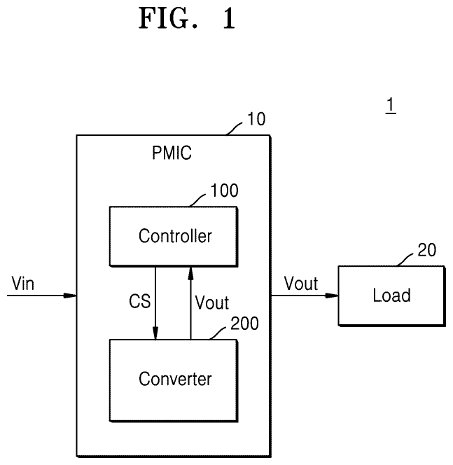

FIG. 1 is a schematic block diagram of a system 1 according to an embodiment.

Referring to FIG. 1, the system 1 may include a power management integrated circuit (PMIC) 10 and a load 20. The PMIC 10 may receive an input voltage Vin and convert the input voltage Vin into an output voltage Vout, and the load 20 may receive the output voltage Vout from the PMIC 10. The PMIC 10 may include a circuit that provides a voltage enabling the operation of the load 20, which performs its designed function based on the output voltage Vout (or output current) from the PMIC 10. In other words, the load 20 refers to any device or component that operates based on the power supplied by the PMIC 10. For example, the load 20 may include a processing circuit which processes a digital signal and/or an analog signal, or may also include a device, which converts electrical energy into other energy, such as a motor, a heater, a lighting device, and a display.

In some embodiments, the PMIC 10 may be included in a semiconductor package. In some embodiments, the system 1 may include a printed circuit board (PCB), and the PMIC 10 and the load 20 may each be mounted on the PCB. In the inventive concept, the PMIC 10 may simply be referred to as a device or an integrated circuit.

The PMIC 10 may include a controller 100 and a converter 200. The controller 100 may manage the overall operation of the PMIC 10, including controlling the operation of the converter 200. In some embodiments, the controller 100 may provide a control signal CS to the converter 200 to control the converter 200 based on an operation mode. The control signal CS may include a signal for controlling a plurality of switches included in the converter 200. For example, as the plurality of switches of the converter 200 are controlled based on the control signal CS of the controller 100, the phase of the converter 200 may be changed. In some embodiments, the controller 100 may also receive the output voltage Vout output by the converter 200 to determine the operation mode. For example, the controller 100 may compare the input voltage Vin to the output voltage Vout of the converter 200 to determine the operation mode, which serves as the basis for controlling the converter 200.

The converter 200 may perform a series of voltage conversion operations by receiving the input voltage Vin and outputting it as the output voltage Vout. In some embodiments, the converter 200 may include the plurality of switches and modify its circuit configuration by controlling these switches based on the control signal CS received from the controller 100 (i.e., changing the phase). In other words, the converter 200 may implement various voltage conversion operations by changing the phase according to the operation mode. The converter 200 may also be referred to as a converting circuit or an integrated circuit.

In other words, the integrated circuit according to an embodiment of the inventive concept can set various operation modes based on a voltage conversion ratio (VCR) between the input voltage Vin and the output voltage Vout. It can stably operate across the entire VCR range by dynamically adjusting and implementing the circuit structure of the converter 200 according to the operation mode.

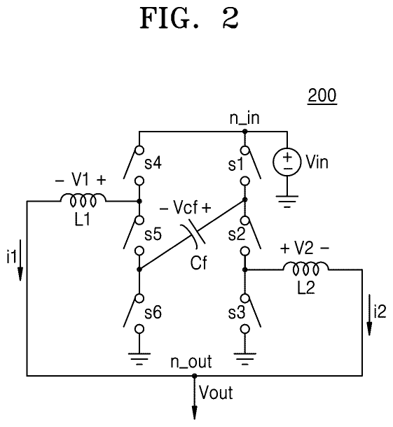

FIG. 2 is a circuit diagram of a converter 200, according to an embodiment.

Referring to FIG. 2, the converter 200 may include a capacitor Cf, a first inductor L1, a second inductor L2, and first through sixth switches s1 through s6. The converter 200 may receive the input voltage Vin from the outside. The converter 200 may implement various phases by controlling the on/off states of switches s1 through s6 according to the operation mode, as described above. The first inductor L1 and the second inductor L2 may have the same inductance.

In some embodiments, first ends of the first switch s1 and the fourth switch s4 may be connected to an input node n_in for receiving the input voltage Vin. A second end of the first switch s1 may be connected to the capacitor Cf, and a second end of the fourth switch s4 may be connected to the first inductor L1. In other words, switching operations of the first switch s1 and the fourth switch s4 determine whether the capacitor Cf and the first inductor L1 directly receive the input voltage Vin. The second switch s2 and the third switch s3 may be sequentially connected in series to the first switch s1, and the fifth switch s5 and the sixth switch s6 may be sequentially connected in series to the fourth switch s4. In this case, a first end of the capacitor Cf may be connected to the first switch s1 and the second switch s2, and a second end of the capacitor Cf may be connected to the fifth switch s5 and the sixth switch s6. The third switch s3 and the sixth switch s6 may each be grounded, and thus the charge stored in the capacitor Cf may be discharged to the load 20 by using the switching operation of each of the third switch s3 and the sixth switch s6. In other words, the on and off states of the first through sixth switches s1 through s6 may be determined by the operation mode, which in turn determines whether the capacitor Cf is charged or discharged (i.e., whether a capacitor voltage Vcf is increased or decreased).

A first end of the first inductor L1 may be connected to the fourth switch s4 and the fifth switch s5, and a second end of the first inductor L1 may be connected to an output node n_out. A first end of the second inductor L2 may be connected to the second switch s2 and the third switch s3, and a second end of the second inductor L2 may be connected to the output node n_out. In other words, a first current i1 of the first inductor L1 and a second current i2 of the second inductor L2 may be added at the output node n_out and supplied to the load 20. Similarly, the output voltage Vout of the output node n_out may be determined and supplied to the load 20 according to a first voltage V1 of the first inductor L1 and a second voltage V2 of the second inductor L2. In other words, the on and off states of the first through sixth switches s1 through s6 may be determined by the operation mode, which in turn determines whether the currents of the first inductor L1 and the second inductor L2 increase or decrease.

In other words, an integrated circuit according to the present embodiment may asymmetrically configure the connections between inductors and capacitors by using switches, and implement various phases by controlling the on and off states of each switch according to the operation mode.

In addition, the integrated circuit may reduce power loss caused by parasitic resistance by using a plurality of inductors having relatively small inductances instead of inductors with large inductances.

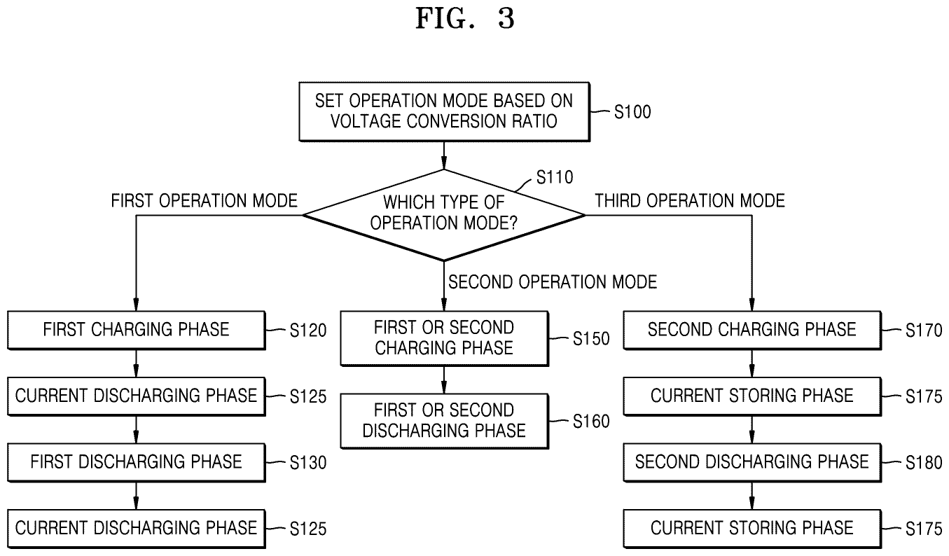

FIG. 3 is a flowchart of an operation of the converter 200 according to an operation mode according to an embodiment.

Referring to FIGS. 1 through 3, the PMIC 10 may determine an operation mode based on the VCR of the input voltage Vin over the output voltage Vout. For example, the controller 100 may receive the output voltage Vout from the converter 200 to compute the VCR.

In some embodiments, in operation S100, the PMIC 10 may determine the operation mode by comparing the VCR to a first reference value and a second reference value, the second value being greater than the first reference value.

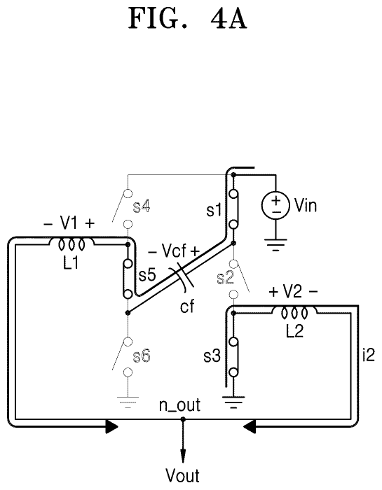

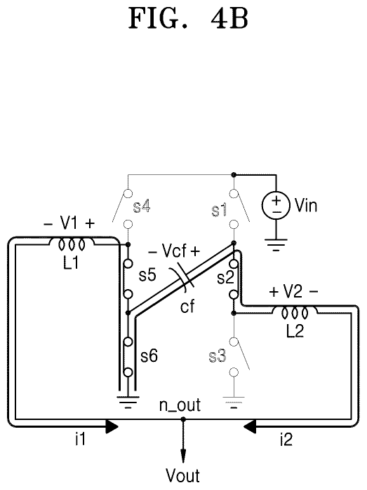

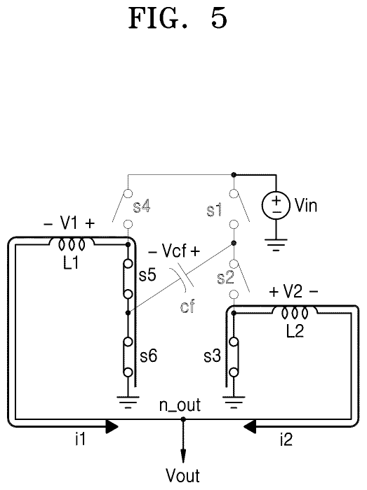

In operation S100, when the VCR is lower than the first reference value, in other words, when the VCR has a lower value than the first reference value, the PMIC 10 may set the operation mode to a first operation mode. When the operation mode is determined to be the first operation mode in operation S110, in operation S120, the converter 200 may operate in a first charging phase to charge the capacitor Cf. After the first charging phase of operation S120, in operation S125, the converter 200 may operate in the current discharging phase. The current stored in the first inductor L1 and the second inductor L2 may be discharged (in other words, the current of the first inductor L1 and the second inductor L2 may be reduced), and in operation S130, the converter 200 may operate in a first discharging phase to discharge the capacitor Cf. After the first discharging phase of operation S130, the current discharging phase of operation S125 may be repeated. This is described below in detail with reference to FIGS. 4A through 5. As long as the first operation mode is maintained, the converter 200 may repeat the phases of operations S120, S125, and S130. However, the phase repetition of operations S120, S125, and S130 is not limited to the present embodiment, and may be variously implemented. For example, the converter 200 may first operate in the first discharging phase of operation S130 depending on the charging status of the capacitor Cf.

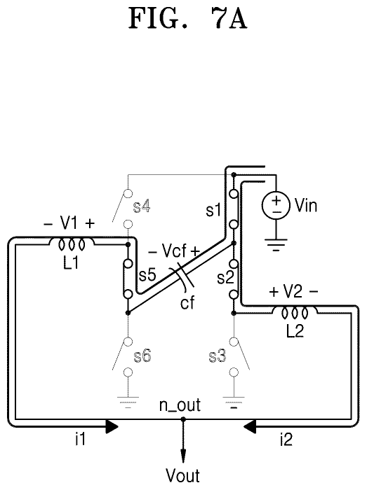

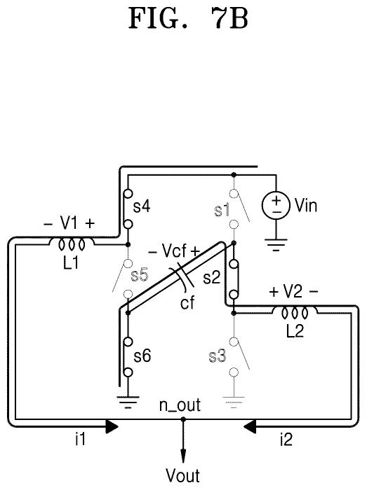

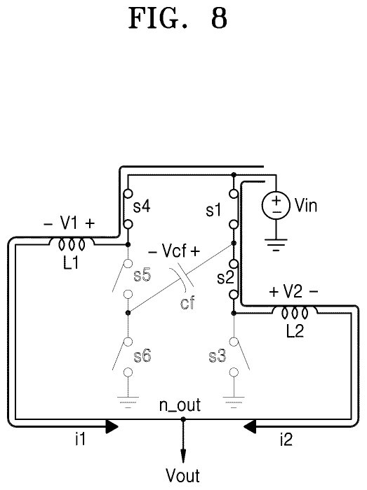

In operation S100, when the VCR is greater than the second reference value, in other words, when the VCR has a larger value than the second reference value, the PMIC 10 may set the operation mode to a third operation mode. When the operation mode is determined to be the third operation mode in operation S110, in operation S170, the converter 200 may operate in a second charging phase to charge the capacitor Cf. After the second charging phase of operation S170, in operation S175, the converter 200 may operate in the current storing phase. The current may be stored in the first inductor L1 and the second inductor L2 (in other words, the current of the first inductor L1 and the second inductor L2 may be increased), and in operation S180, the converter 200 may operate in a second discharging phase to discharge the capacitor Cf. After the second discharging phase of operations S180, the current storing phase of operation S175 may be repeated. This is described below in detail with reference to FIGS. 7A through 8. As long as the third operation mode is maintained, the converter 200 may repeat the phases of operations S170, S175, and S180. However, the phase repetition of operations S170, S175, and S180 is not limited to the present embodiment, and may be variously implemented. For example, the converter 200 may first operate in the second discharging phase of operation S180 depending on the charging status of the capacitor Cf.

In operation S100, when the VCR is greater than the first reference value and less than the second reference value, in other words, when the VCR has a medium value, the PMIC 10 may set the operation mode to a second operation mode. When the operation mode is determined to be the second operation mode in operation S110, in operation S150, the converter 200 may operate in the first charging phase or the second charging phase to charge the capacitor Cf. After the capacitor Cf is charged, in operation S160, the converter 200 may operate in the first discharging phase or the second discharging phase to discharge the capacitor Cf.

FIGS. 4A and 4B are circuit diagrams of a charging phase and a discharging phase of the capacitor Cf, respectively, according to embodiments. FIG. 5 is a circuit diagram of a current discharging phase of first and second inductors L1 and L2, according to an embodiment.

Referring to FIGS. 4A and 4B, in the first operation mode, in other words, when the VCR is less than the first reference value, the converter 200 may control the first through sixth switches s1 through s6 to charge or discharge the capacitor Cf. In some embodiments, the controller 100 may set the operation mode to the first operation mode as described above based on the computation of the VCR, and may provide the control signal CS to the converter 200 for controlling the converter 200 in the first operation mode. The converter 200 may control the first through sixth switches s1 through s6 based on the control signal CS.

Referring to FIG. 4A, the converter 200 may turn on only the first switch s1, the third switch s3, and the fifth switch s5 to operate in the first charging phase. In other words, the capacitor Cf may receive the input voltage Vin, and store an electric charge by using the input voltage Vin. Referring to FIG. 4B, the converter 200 may turn on only the second switch s2, the fifth switch s5, and the sixth switch s6 to operate in the first discharging phase. In other words, the capacitor Cf may discharge its stored charge into the load 20 (in other words, the capacitor Cf may be discharged).

Referring to FIG. 5, the converter 200 may turn on only the third switch s3, the fifth switch s5, and the sixth switch s6 to discharge the current stored in the first inductor L1 and the second inductor L2, to reduce the current in the first and second inductors L1 and L2. In other words, the first inductor L1 and the second inductor L2 may discharge the current toward the load 20.

In this case, because the amount of charge stored in the capacitor Cf must equal the amount discharged in the first operation mode, the amount of the first current i1 flowing through the first inductor L1 may be the same as the amount of the second current i2 flowing through the second inductor L2. Because the inductance of the first inductor L1 is the same as the inductance of the second inductor L2, the voltage at both ends of the first inductor L1 may be the same as the voltage at both ends of the second inductor L2. As a result, the voltage at both ends of the capacitor Cf may be half of the input voltage Vin. Thus, the first current i1 of the first inductor L1 and the second current i2 of the second inductor L2 may operate while in balance with a phase difference of about 180 degrees.

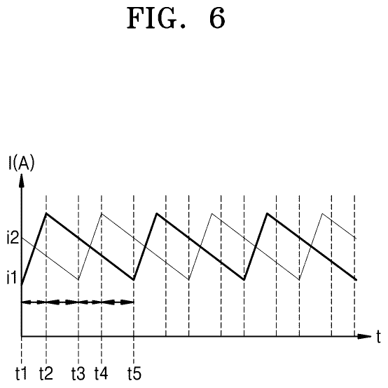

FIG. 6 is a graph of a waveform of an inductor current in an operation mode, according to an embodiment.

Referring to FIG. 6, in the first operation mode, the converter 200 may operate to maintain balance between the first current i1 of the first inductor L1 and the second current i2 of the second inductor L2. A period from a first time point t1 to a second time point t2 may be a period in which the first current i1 increases, the second current i2 decreases, and the capacitor Cf is charged, in other words, the first charging phase. After the first charging phase, a period from the second time point t2 to a third time point t3 may be a period in which both the first current i1 and the second current i2 decrease, in other words, the current discharging phase in which the current stored in the first inductor L1 and the second inductor L2 is discharged.

Thereafter, a period from the third time point t3 to a fourth time point t4 may be a period in which the first current i1 decreases and the second current i2 increases so that the capacitor Cf is discharged, in other words, the first discharging phase. After the first discharging phase, a period from the fourth time point t4 to a fifth time point t5 may be a period in which the current discharging phase operates again, and in this manner, the period from the first time point t1 to the fifth time point t5 may be repeated.

In other words, as described above, the converter 200 according to an embodiment of the inventive concept may operate by maintaining balance between the first current i1 of the first inductor L1 and the second current i2 of the second inductor L2, with a phase difference of about 180 degrees.

FIGS. 7A and 7B are circuit diagrams of a charging phase and a discharging phase of the capacitor Cf, respectively, according to embodiments.

FIG. 8 is a circuit diagram of a current storing phase of the first and second inductors L1 and L2, according to an embodiment.

Referring to FIGS. 7A and 7B, in the third operation mode, in other words, when the VCR is greater than the second reference value, the converter 200 may control the first through sixth switches s1 through s6 to charge or discharge the capacitor Cf. In some embodiments, the controller 100 may set the operation mode to the third operation mode as described above based on the computation of the VCR, and may provide the control signal CS to the converter 200 for controlling the converter 200 in the third operation mode. The converter 200 may control the first through sixth switches s1 through s6 based on the control signal CS.

Referring to FIG. 7A, the converter 200 may turn on only the first switch s1, the second switch s2, and the fifth switch s5 to operate in the second charging phase. In other words, the capacitor Cf may receive the input voltage Vin, and charge the capacitor Cf by using the received input voltage Vin. Referring to FIG. 7B, the converter 200 may turn on only the second switch s2, the fourth switch s4, and the sixth switch s6 to operate in the second discharging phase. In other words, the capacitor Cf may discharge it charge to the load 20 (, the capacitor Cf may be discharged).

Referring to FIG. 8, the converter 200 may turn on only the first switch s1, the second switch s2, and the fourth switch s4 to store current in the first inductor L1 and the second inductor L2. In other words, the first inductor L1 and the second inductor L2 may store the current by being connected to the input voltage Vin.

In this case, since the amount of charge stored in and discharged from the capacitor Cf must be equal in the third operation mode, the first current i1 flowing through the first inductor L1 must match the second current i2 flowing through the second inductor L2. Given that the inductance of the first inductor L1 is the same as that of the second inductor L2, the voltage across the first and second inductors L1 and L2 will also be the same. As a result, the voltage across the capacitor Cf will be half of the input voltage Vin. Thus, the first current i1 in the first inductor L1 and the second current i2 in the second inductor L2 will operate in balance, maintaining a phase difference of approximately 180 degrees.

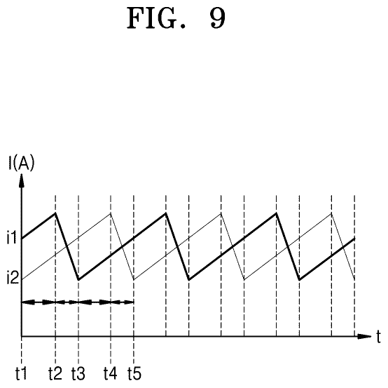

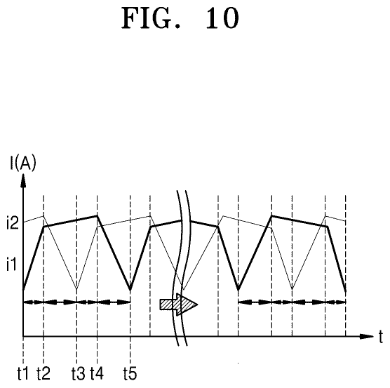

FIGS. 9 and 10 are graphs of waveforms of an inductor current in the operation mode, according to embodiments.

Referring to FIG. 9, in the third operation mode, the converter 200 may operate to maintain balance between the first current i1 of the first inductor L1 and the second current i2 of the second inductor L2. The period from the first time point t1 to the second time point t2 may be a period in which both the first current I1 and the second current i2 increase, in other words, the current storing phase in which current is stored in the first inductor L1 and the second inductor L2. The period from the second time point t2 to the third time point t3 may be a period in which the first current i1 decreases, the second current i2 increases, and the capacitor Cf is charged, in other words, the second charging phase. After the second charging phase, the period from the third time point t3 to the fourth time point t4 may be the current storing phase in which the current is stored in the first inductor L1 and the second inductor L2 again, and then the period from the fourth time point t4 to the fifth time point t5 may be a period in which the first current i1 increases, the second current i2 decreases, and the capacitor Cf is discharged, in other words, the second discharging phase. In this manner, the period from the first time point t1 to the fifth time point t5 may be repeated.

In other words, as described above, the converter 200 according to an embodiment of the inventive concept may operate by maintaining balance between the first current i1 of the first inductor L1 and the second current i2 of the second inductor L2, with a phase difference of about 180 degrees.

In some embodiments, in the second operation mode, in other words, when the VCR is greater than the first reference value and less than the second reference value, the converter 200 may control the first through sixth switches s1 through s6 to charge or discharge the capacitor Cf. As described above, the converter 200 may operate in the first charging phase or the second charging phase to charge the capacitor Cf, and may operate in the first discharging phase or the second discharging phase to discharge the capacitor Cf.

Referring to FIG. 10, the converter 200 may operate to maintain balance between the first current i1 of the first inductor L1 and the second current i2 of the second inductor L2 in the second operation mode. In the period from the first time point t1 to the second time point t2, the converter 200 may operate in the second discharging phase to discharge the capacitor Cf, and in the period from the second time point t2 to the third time point t3, the converter 200 may operate in the first charging phase to charge the capacitor Cf. In this manner, the converter 200 may operate in the first charging phase or the second charging phase to charge the capacitor Cf, and alternatively in the first discharging phase or the second discharging phase to discharge the capacitor Cf.

In other words, the integrated circuit according to an embodiment of the inventive concept can maintain balanced currents through the inductors across the entire VCR range by setting an operation mode based on the VCR and variously changing the phases by using the switching operations of the converter 200. As a result, the integrated circuit according to an embodiment of the inventive concept can reduce current ripple and effectively reduce power loss across the entire VCR range.

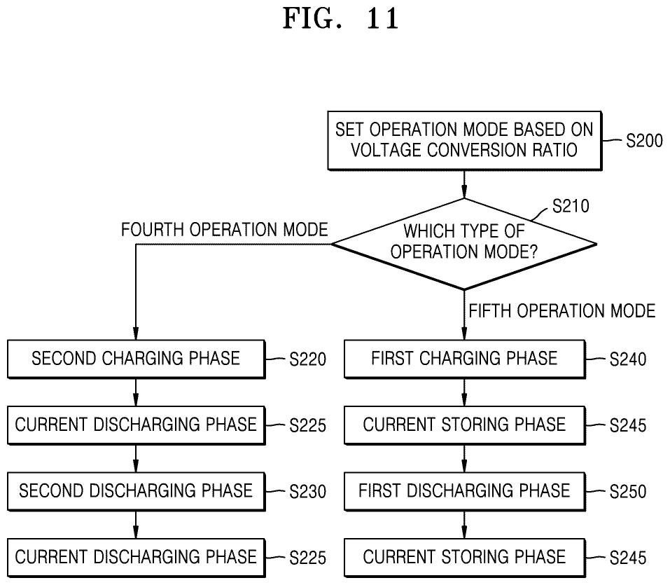

FIG. 11 is a flowchart of an operation of the converter based on an operation mode, according to an embodiment.

Referring to FIGS. 1, 3, and 11, as described above, the PMIC 10 may determine an operation mode based on the VCR of the input voltage Vin over the output voltage Vout, and the PMIC 10 may compare the VCR to the first reference value or the second reference value. In this case, when the VCR is the first reference value (or close to the first reference value) (hereinafter, a first dead zone) or when the VCR is the second reference value (or close to the second reference value) (hereinafter, a second dead zone), in other words, near the boundary of the first through third operation modes, the operation of the converter 200 may not be smooth. For example, errors in the actual duty cycle may occur due to direct current (DC) resistance of the first inductor L1 and the second inductor L2, or the on-resistance of the first through sixth switches s1 through s6, potentially causing the converter 200 to malfunction.

In some embodiments, in operation S200, the PMIC 10 may determine the operation mode by comparing the VCR to the first reference value and the second reference value.

In operation S200, when the VCR is the first reference value (or a value close to the first reference value), the PMIC 10 may set the operation mode to the fourth operation mode. In some embodiments, even when the VCR is a value close to the first reference value, in other words, when the difference between the VCR and the first reference value is within a certain (for example, preset) range, the PMIC 10 may set the operation mode to the fourth operation mode. In other words, even if the VCR deviates slightly from the first reference value, the PMIC 10 can respond more flexibly to the first dead zone by switching to the fourth operation mode. When the operation mode is determined to be the fourth operation mode in operation S210, in operation S220, the converter 200 may operate in the second charging phase to charge the capacitor Cf. After the second charging phase of operations S220, in operation S225, the converter 200 may operate in the current discharging phase. In other words, the currents stored in the first inductor L1 and the second inductor L2 may be discharged. In operation S230, the converter 200 may operate in the second discharging phase to discharge the capacitor Cf. After the second discharging phase of operations S230, the current discharging phase of operation S225 may be repeated. As described above, the converter 200 may repeat the phases of operations S220, S225, and S230 as long as the fourth operation mode is maintained.

In operation S200, when the VCR is the second reference value (or a value close to the second reference value), the PMIC 10 may set the operation mode to a fifth operation mode. In some embodiments, even when the VCR is a value close to the second reference value, in other words, when the difference between the VCR and the second reference value is within a certain (for example, preset) range, the PMIC 10 may set the operation mode to the fifth operation mode. In other words, even when the VCR has a certain error from the second reference value, the PMIC 10 may respond more flexibly to the second dead zone by setting the operation mode to the fifth operation mode. When the operation mode is determined to be the fifth operation mode in operation S210, in operation S240, the converter 200 may operate in the first charging phase to charge the capacitor Cf. After the first charging phase of operation S240, in operation S245, the converter 200 may operate in the current storing phase. In other words, the currents may be stored in the first inductor L1 and the second inductor L2. In operation S250, the converter 200 may operate in the first discharging phase to discharge the capacitor Cf. After the first discharging phase of operation S250, the current storing phase of operation S245 may be repeated. As described above, the converter 200 may repeat the phases of operations S240, S245, and S250 as long as the fifth operation mode is maintained.

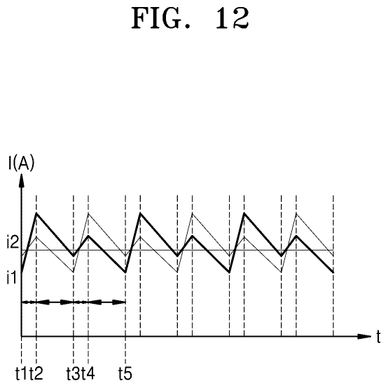

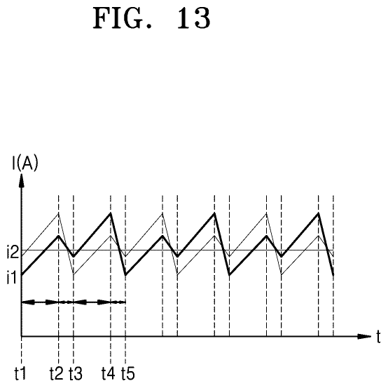

FIGS. 12 and 13 are graphs of waveforms of inductor currents in an operation mode, according to embodiments.

Referring to FIG. 12, the converter 200 may operate to maintain balance between the first current i1 of the first inductor L1 and the second current i2 of the second inductor L2 in the fourth operation mode. The period from the first time point t1 to the second time point t2 may be a second discharging phase in which the discharge of the capacitor Cf occurs, and the period from the second time point t2 to the third time point t3 may be a period in which both the first current i1 and the second current i2 decrease, in other words, the current discharging phase in which the current stored in the first inductor L1 and the second inductor L2 is discharged. Thereafter, the period from the third time point t3 to the fourth time point t4 may be a period in which charging of the capacitor Cf occurs, in other words, the second charging phase. After the second charging phase, the period from the fourth time point t4 to the fifth time point t5 may be a period in which the current discharging phase operates again, and in this manner, the period from the first time point t1 to the fifth time point t5 may be repeated.

Referring to FIG. 13, the converter 200 may operate to maintain balance between the first current i1 of the first inductor L1 and the second current i2 of the second inductor L2 in the fifth operation mode. The period from the first time point t1 to the second time point t2 may be a period in which both the first current I1 and the second current i2 increase, in other words, the current storing phase in which current is stored in the first inductor L1 and the second inductor L2. The period from the second time point t2 to the third time point t3 may be the first charging phase in which the capacitor Cf is charged, and thereafter, the period from the third time point t3 to the fourth time point t4 may be the current storing phase in which the current is stored in the first inductor L1 and the second inductor L2 again. Thereafter, the period from the fourth time point t4 to the fifth time point t5 may be the first discharging phase in which the discharge of the capacitor Cf occurs, and in this manner, the period from the first time point t1 to the fifth time point t5 may be repeated.

In other words, when the VCR is equal to or close to the reference values, the integrated circuit according to an embodiment of the inventive concept can introduce additional operation modes for smoother operation. In this case, the phases from existing operation modes may be used, allowing the integrated circuit to function smoothly near the reference value boundaries without requiring additional devices or phases. Consequently, the integrated circuit can maintain balanced currents through the inductors across the entire VCR range, particularly near the boundary values

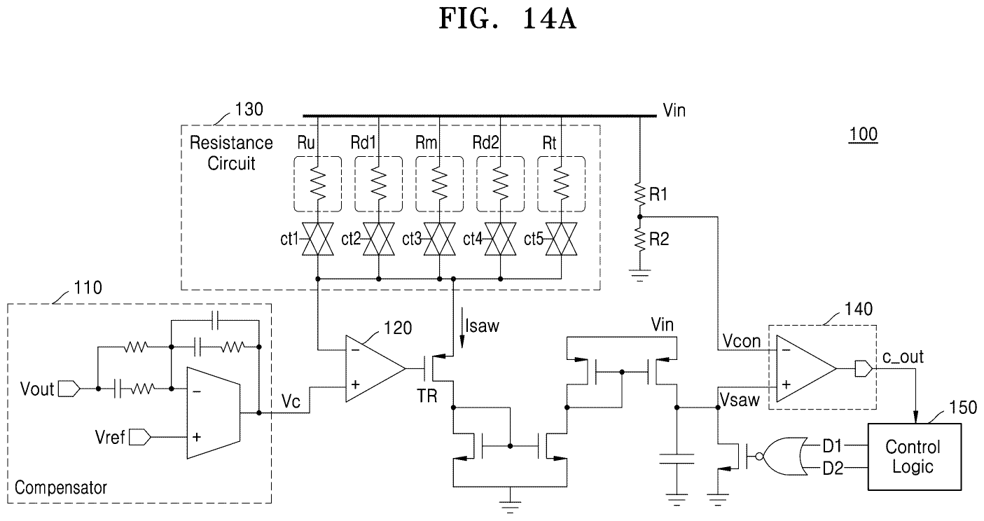

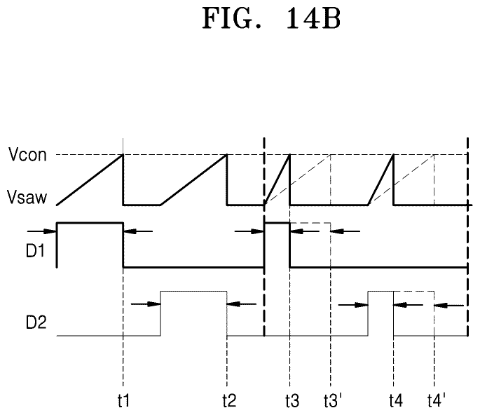

FIGS. 14A and 14B are diagrams to explain the controller 100 and its operation, respectively, according to embodiments.

Referring to FIGS. 1, 14A, and 14B, the controller 100 according to embodiments of the inventive concept may include a compensator 110, an amplifier 120, a resistance circuit 130, a comparator 140, and a control logic 150.

The integrated circuit according to embodiments of the inventive concept may operate based on the plurality of operation modes as described above. When the operation mode changes, the optimal duty cycle value may also change, resulting in a significant change in the output voltage Vout. For example, when the operation mode changes from the first operation mode to the second operation mode (or from the first operation mode to the fourth operation mode corresponding to the first dead zone) based on the VCR, the optimal duty cycle value may change. In this case, the duty cycle value may gradually decrease by reducing the output of the compensator 110. However, even as the duty cycle decreases slowly, it may not prevent the current or output voltage Vout of the first inductor L1 and the second inductor L2 from changing rapidly. As a result, a sudden change in the output voltage Vout may occur each time the operation mode is switched.

The compensator 110 may receive the output voltage Vout and a reference voltage Vref and output a compensation voltage Vc by using a series of correction operations. In this case, the integrated circuit according to an embodiment of the inventive concept may not directly provide the compensation voltage Vc to the comparator 140, but may provide a voltage Vsaw that has undergone correction operations by using the amplifier 120.

In some embodiments, the integrated circuit according to an embodiment of the inventive concept may further include the resistance circuit 130. The resistance circuit 130 may include a plurality of resistors for correcting the voltage Vsaw with an optimal duty cycle in each of the operation modes described above. In some embodiments, the resistance circuit 130 may include a first resistor Ru to match the optimal duty cycle in the first operation mode, a second resistor Rd1 to match the optimal duty cycle in the fourth operation mode (an operation mode in the first dead zone), a third resistor Rm to match the optimal duty cycle in the second operation mode, a fourth resistor Rd2 to match the optimal duty cycle in the fifth operation mode (an operation mode in the second dead zone), and a fifth resistor Rt to match the optimal duty cycle in the third operation mode. For example, the resistance values of the first resistor Ru through the fifth resistor Rt may be preset based on the circuit configuration so that the converter 200 operates at the optimal duty cycle. In other words, the controller 100 may correct the voltage Vsaw by selectively connecting the first resistor Ru through fifth resistor Rt to the amplifier 120, corresponding to each operation mode.

In some embodiments, each of the first resistor Ru through fifth resistor Rt may be connected in series to a corresponding transmission gate TG. Each of the transmission gates TG may be turned on or off based on a corresponding control signal among a first RG control signal ct1 through a fifth TG control signal ct5. In other words, resistors set for each operation mode (to ensure that the converter 200 operates at the optimal duty cycle for that mode) may be selectively connected to a transistor TR at an input terminal and an output terminal of the amplifier 120. The transistor TR may include a p-channel metal oxide semiconductor (PMOS) transistor.

A first input terminal of the amplifier 120 may be connected to the compensator 110 to receive the compensation voltage Vc that is an output of the compensator 110, and a second input terminal of the amplifier 120 may be selectively connected to at least one of the first resistor Ru through fifth resistor Rt. First ends of each of the first resistor Ru through fifth resistor Rt may be connected to an input voltage Vin. In this manner, the voltage Vsaw may be corrected by using the connection relationship between the compensator 110, the amplifier 120, and the resistance circuit 130.

In an embodiment, a current value of a current Isaw flowing through the transistor TR may be a value obtained by subtracting the compensation voltage Vc from the input voltage Vin and by dividing the subtracted compensation voltage Vc by a resistance value Rselect of a resistor selected from the first resistor Ru through fifth resistor Rt. In other words, the controller 100 may instantaneously change the current Isaw by selecting a resistor corresponding to each operation mode in the resistance circuit 130 and connecting the resistor to the amplifier 120. As a result, the controller 100 may also instantaneously change the voltage Vsaw. The comparator 140 may receive the voltage Vsaw and a constant voltage Vcon, and may provide a comparison result to the control logic 150. For example, when the instantaneously changed voltage Vsaw is greater than the constant voltage Vcon, the comparator 140 may output an output signal c_out having a logic high level and transmit the output signal c_out to the control logic 150.

The control logic 150 may output a first signal D1 and a second signal D2 for controlling various phases of the converter 200. In the embodiment, as described above with reference to FIGS. 4A through 5, when the VCR is less than the first reference value, the converter 200 may operate in the current discharging phase after the first charging phase, and the first signal D1 may determine a time point at which the first signal DI operates in the current discharging phase. For example, referring to FIG. 14B, when the first signal DI transitions to a logic low level at the first time point t1, the converter 200 may operate in the current discharging phase. Similarly, when the VCR is less than the first reference value, the converter 200 may operate in the current discharging phase after the first discharging phase, and may determine a time point at which the second signal D2 operates in the current discharging phase. For example, as the second signal D2 transitions to a logic low level at the second time point t2, the converter 200 may operate in the current discharging phase.

In some embodiments, as described above, the comparator 140 may output the output signal c_out having a logic high level when the instantaneously changed voltage Vsaw by the resistance circuit 130 is greater than the constant voltage Vcon. The control logic 150 may then transition the first signal D1 or the second signal D2 to a logic low level in response to the output signal c_out at a logic high level. In other words, as the voltage Vsaw momentarily changes (as a slope of a waveform of the voltage Vsaw increases), the time point at which the first signal D1 transitions to a logic low level may change from a time point t3′ to a time point t3, and a time point at which the second signal D2 transitions to a logic low level may change from a time point t4′ to a time point t4.

In other words, the controller 100 can adjust the timing at which the first signal D1 and the second signal D2 transition from a logic high level to a logic low level by selecting a resistor corresponding to each operation mode in the resistance circuit 130 and instantly modify the voltage Vsaw. As a result, the duty cycle can be instantly adjusted to the optimal value for each operation mode.

In the embodiment, when the fourth operation mode is changed to the second operation mode, the controller 100 may disconnect the second resistor Rd1 from the amplifier 120 by using a second TG control signal ct2, and may connect the third resistor Rm to the amplifier 120 by using a third TG control signal ct3. In this case, as the resistance value applied to the amplifier 120 decreases rapidly, the current Isaw may increase rapidly. Consequently, the duty cycle adjusts to the optimal value as the transition time points of the first signal DI and the second signal D2 shift due to the rapid increase in the voltage Vsaw. Thus, the currents flowing through the first inductor L1 and the second inductor L2 of the converter 200 may not be significantly changed, and a change in the output voltage Vout according to the change in the operation mode may be significantly reduced.

In some embodiments, the controller 100 may provide the constant voltage Vcon to the comparator 140 based on the input voltage Vin. For example, a constant voltage Vcon may be generated by appropriately adjusting the input voltage Vin using a resistor R1 and a resistor R2. In addition, the controller 100 may further include a plurality of transistors arranged in a mirror structure to transmit the current Isaw flowing in the transistor TR to the comparator 140.

In other words, the integrated circuit according to an embodiment of the inventive concept may maintain the optimal duty cycle by providing a corrected voltage, achieved through the selective connection of resistors, to the comparator 140. As a result, the integrated circuit may prevent rapid changes in the inductor current and the output voltage Vout due to changes in the operation modes. Accordingly, the integrated circuit according to an embodiment of the inventive concept may operate stably over the entire range of the VCR.

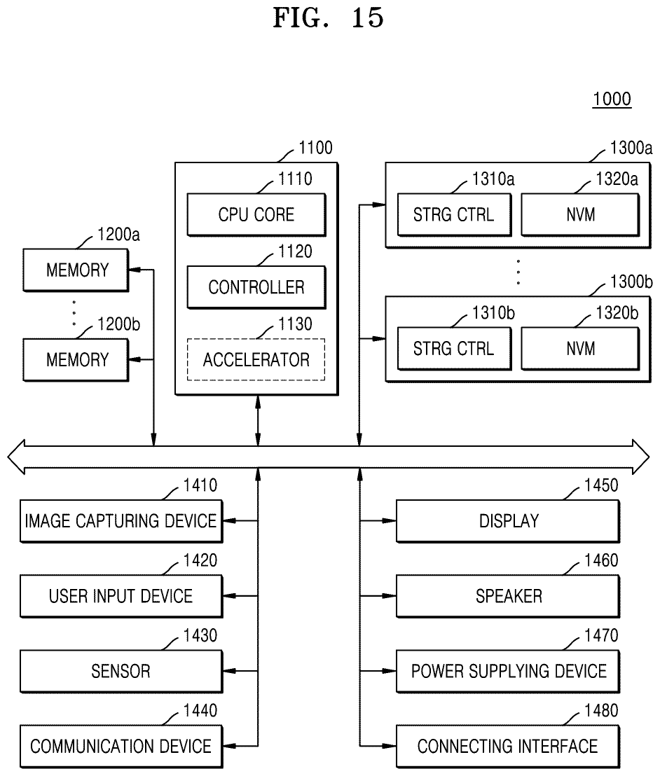

FIG. 15 is a system 1000 including an integrated circuit according to an embodiment.

The system 1000 of FIG. 15 may include a mobile system such as a mobile phone, a smartphone, a tablet personal computer (PC), a wearable device, a health care device, or an Internet of Things (IoT) device. However, the system 1000 of FIG. 15 is not necessarily limited to the mobile system, and may also include a PC, a laptop computer, a server, a media player, or an automotive device such as a navigation device.

Referring to FIG. 15, the system 1000 may include a main processor 1100, memories 1200a and 1200b, and storage devices 1300a and 1300b, and in addition, may include one or more of an image capturing device 1410, a user input device 1420, a sensor 1430, a communication device 1440, a display 1450, a speaker 1460, a power supplying device 1470, and a connecting interface 1480.

In this case, the power supplying device 1470 configured to supply power to the components constituting the system 1000 of FIG. 15. The main processor 1100, the memories 1200a and 1200b, the storage devices 1300a and 1300b, the image capturing device 1410, the user input device 1420, the sensor 1430, the communication device 1440, the display 1450, the speaker 1460, and the connecting interface 1480, may be implemented by using the embodiments described above with reference to FIGS. 1 through 14 (in other words, the integrated circuit or the PMIC according to embodiments of the inventive concept).

The main processor 1100 may control an entire operation of the system 1000, and more particularly, may control operations of other components constituting the system 1000. The main processor 1100 may be implemented as a general purpose processor, a dedicated processor, an application processor, etc.

The main processor 1100 may include one or more CPU cores 1110, and may further include a controller 1120 for controlling the memories 1200a and 1200b and/or the storage devices 1300a and 1300b. According to an embodiment, the main processor 1100 may further include an accelerator 1130, which is a dedicated circuit for high speed data computation such as an artificial intelligence (AI) data computation. The accelerator 1130 may include a graphics processing unit (GPU), a neural processing unit (NPU), and/or a data processing unit (DPU), or the like, and may be implemented as a separate chip, which is physically independent of other components of the main processor 1100.

The memories 1200a and 1200b may be used as a main memory device of the system 1000, and may include a volatile memory such as static random access memory (RAM) (SRAM) and/or dynamic RAM (DRAM), but may also include a non-volatile memory, such as a flash memory, phase change RAM (PRAM), and/or resistive RAM (RRAM). The memories 1200a and 1200b may be implemented in the same package as the main processor 1100.

The storage devices 1300a and 1300b may function as a non-volatile storage device for storing data regardless of power supply, and may have a relatively larger storage capacity than the memories 1200a and 1200b. The storage devices 1300a and 1300b may respectively include storage controllers 1310a and 1310b, and non-volatile memories (NVM) 1320a and 1320b for storing data under control by the storage controllers 1310a and 1310b. The NVMs 1320a and 1320b may include a vertical (V)-NAND flash memory having a 2-dimensional (2D) or a 3-dimensional (3D) V-NAND structure, but may also include NVMs of different types, such as PRAM and/or RRAM.

The storage devices 1300a and 1300b may also be included in the system 1000 physically separate from the main processor 1100, and may also be implemented in the same package as the main processor 1100. In addition, the storage devices 1300a and 1300b may have the same shape as a solid state drive (SSD) or a memory card, and accordingly, may be also detachably combined with other components of the system 1000 via an interface such as the connecting interface 1480 to be described below. The storage devices 1300a and 1300b may include a device to which standard conventions, such as universal flash storage (UFS), embedded multimedia card (eMMC), and NVM express (NVMe) are applied, but are not necessarily limited thereto.

The image capturing device 1410 may capture static images or video images, and may include a camera, a camcorder, and/or a webcam, etc.

The user input device 1420 may receive various types of data input by a user of the system 1000, and may include a touch pad, a keyboard, a mouse, and/or a microphone, etc.

The sensor 1430 may sense various types of physical quantifies from outside the system 1000, and may convert the sensed physical quantity into an electrical signal. The sensor 1430 may include a temperature sensor, a pressure sensor, an illuminance sensor, a location sensor, an acceleration sensor, a biosensor, and/or a gyroscope, etc.

The communication device 1440 can transmit and receive signals between external devices and the system 1000, following various communication protocols. The communication device 1440 may be implemented by including an antenna, a transceiver, and/or a modulator/demodulator (MODEM), etc.

The display 1450 and the speaker 1460 may function as output devices for outputting visual information and audio information to a user of the system 1000, respectively.

The power supplying device 1470 can appropriately convert power from a battery embedded in the system 1000 and/or from an external power source, delivering it to each component of the system 1000 by adjusting the converter's structure according to the operation mode, as described in FIGS. 1 through 14. In other words, the power supplying device 1470 in this embodiment of the inventive concept can operate stably across the entire VCR range and efficiently supply power while minimizing power loss during the supply process

The connecting interface 1480 may provide a connection between the system 1000, and an external device connected to the system 1000 to exchange data with the system 1000. The connecting interface 1480 may be implemented in various interface methods, such as advanced technology attachment (ATA), serial ATA (SATA), external SATA (e-SATA), small computer system interface (SCSI), serial attached SCSI (SAS), peripheral component interconnect (PCI), PCI express (PCIe), node version manager (NVM) express (NVMe), IEEE 1394, universal serial bus (USB), a secure digital (SD) card, a multi-media card (MMC), an embedded multi-media card (eMMC), and a compact flash (CF) card.

While the inventive concept has been particularly shown and described with reference to embodiments thereof, it will be understood that various change in form and detail may be made thereto without departing from the spirit and scope of the inventive concept as set forth in the following claims.

What is claimed is:

1. An integrated circuit comprising:
an input node configured to receive an input voltage;
a first switch, a second switch, and a third switch sequentially connected in series between the input node and a ground terminal;
a fourth switch, a fifth switch, and a sixth switch sequentially connected in series between the input node and the ground terminal;
a capacitor including a first end connected to the first switch and the second switch, and a second end connected to the fifth switch and the sixth switch;
a first inductor including a first end connected to the fourth switch and the fifth switch, and a second end connected to an output node;
a second inductor including a first end connected to the second switch and the third switch, and a second end connected to the output node; and
a controller configured to control the first switch through the sixth switch.

2. The integrated circuit of claim 1, wherein
the controller is configured to determine an operation mode based on a voltage conversion ratio, which is a ratio of an output voltage of the output node to the input voltage, and perform switching operations on the first switch through the sixth switch.

3. The integrated circuit of claim 2, wherein
the controller is configured to determine the operation mode by comparing the voltage conversion ratio to at least one of a first reference value and a second reference value, the second value being greater than the first reference value.

4. The integrated circuit of claim 3,
wherein, when the voltage conversion ratio is less than the first reference value, the controller,
when the capacitor is charged, turns on the first switch, the third switch, and the fifth switch, and turns off the second switch, the fourth switch and the sixth switch, and
when the capacitor is discharged, turns on the second switch, the fifth switch, and the sixth switch, and turns off the first switch, the third switch, and the fourth switch.

5. The integrated circuit of claim 3,
wherein, when the voltage conversion ratio is less than the first reference value, the controller turns on the third switch, the fifth switch, and the sixth switch, and turns off the first switch, the second switch, and the fourth switch, to discharge current of the first inductor and the second inductor.

6. The integrated circuit of claim 3,
wherein, when the voltage conversion ratio is greater than the first reference value and less than the second reference value, the controller,
when the capacitor is charged, turns on the first switch, the fifth switch and either the second switch or the third switch, turns off any one of the second and third switches not turned on, and turns off the sixth switch and the fourth switch, and
when the capacitor is discharged, turns on the second switch, the sixth switch and either the fourth switch or the fifth switch, turns off any one of fourth and fifth switches not turned on, and turns off the first switch and the third switch.

7. The integrated circuit of claim 3,
wherein, when the voltage conversion ratio is greater than the second reference value, the controller,
when the capacitor is charged, turns on the first switch, the second switch, and the fifth switch, and turns off the third switch, the fourth switch, and the sixth switch, and
when the capacitor is discharged, turns on the second switch, the fourth switch, and the sixth switch, and turns off the first switch, the third switch, and the fifth switch.

8. The integrated circuit of claim 3,
wherein, when the voltage conversion ratio is greater than the second reference value, the controller,
turns on the first switch, the second switch, and the fourth switch, and turns off the third switch, the fifth switch, and the sixth switch, to store current in the first inductor and the second inductor.

9. The integrated circuit of claim 3,
wherein, when a difference between the voltage conversion ratio and the first reference value is in a certain range, the controller,
when the capacitor is charged, turns on the first switch, the second switch, and the fifth switch, and turns off the third switch, the fourth switch, and the sixth switch, and
when the capacitor is discharged, turns on the second switch, the fourth switch, and the sixth switch, and turns off the first switch, the third switch, and the fifth switch.

10. The integrated circuit of claim 3,
wherein, when a difference between the voltage conversion ratio and the first reference value is in a certain range, the controller,
turns on the third switch, the fifth switch, and the sixth switch, and turns off the first switch, the second switch, and the fourth switch, to discharge current of the first inductor and the second inductor.

11. The integrated circuit of claim 3,
wherein, when a difference between the voltage conversion ratio and the second reference value is in a certain range, the controller,
when the capacitor is charged, turns on the first switch, the third switch, and the fifth switch, and turns off the second switch, the fourth switch, and the sixth switch, and
when the capacitor is discharged, turns on the second switch, the fifth switch, and the sixth switch, and turns off the first switch, the third switch, and the fourth switch.

12. The integrated circuit of claim 3,
wherein, when a difference between the voltage conversion ratio and the second reference value is in a certain range, the controller,
turns on the first switch, the second switch, and the fourth switch, and turns off the third switch, the fifth switch, and the sixth switch, to store current in the first inductor and the second inductor.

13. The integrated circuit of claim 2, wherein
the controller further comprises:
a compensator configured to receive the output voltage and generate a compensation voltage;
an amplifier configured to receive the compensation voltage;
a plurality of resistors selectively connected to the amplifier; and
a comparator configured to output an output signal based on an output of the amplifier,
wherein the controller controls a duty cycle to correspond to the operation mode based on the output signal.

14. The integrated circuit of claim 13, wherein
the controller further comprises a plurality of switches respectively connected to the plurality of resistors, and
turns on at least one of the plurality of switches in response to the operation mode.

15. An integrated circuit comprising:
an input node configured to receive an input voltage;
a first inductor and a second inductor;
a capacitor including a first end connected to the first inductor and a ground terminal via at least one switch, and including a second end connected to the second inductor and the input node via at least one switch;
a plurality of switches configured to set connections between the input node, the ground terminal, the first inductor, the second inductor, and the capacitor based on an operation mode;
an output node connected to the first inductor and the second inductor, and configured to provide an output voltage to a load; and
a controller configured to control the plurality of switches.

16. The integrated circuit of claim 15, wherein
the controller is configured to determine the operation mode according to a voltage conversion ratio that is a ratio of the output voltage to the input voltage.

17. The integrated circuit of claim 16,
wherein, when the voltage conversion ratio is less than a first reference value, the controller,
when the capacitor is charged, respectively connects first and second ends of the capacitor to the first inductor and a voltage source, and connects the second inductor to the ground terminal, and
when the capacitor is discharged, respectively connects first and second ends of the capacitor to the second inductor and the ground terminal, and connects the first inductor to the capacitor.

18. The integrated circuit of claim 16,
wherein, when the voltage conversion ratio is greater than a first reference value and less than a second reference value, the controller,
when the capacitor is charged, respectively connects first and second ends of the capacitor to the first inductor and a voltage source, and connects the second inductor to the capacitor or the ground terminal, and
when the capacitor is discharged, respectively connects first and second ends of the capacitor to the second inductor and the ground terminal, and connects the first inductor to the voltage source or the capacitor.

19. The integrated circuit of claim 16,
wherein, when the voltage conversion ratio is greater than a second reference value, the controller,
when the capacitor is charged, connects the first end of the capacitor to the first inductor, and connects the second end of the capacitor to the second inductor and a voltage source, and
when the capacitor is discharged, respectively connects first and second ends of the capacitor to the second inductor and the ground terminal, and connects the first inductor to the voltage source.

20. A method of controlling an integrated circuit,
wherein the integrated circuit comprises: an input node configured to receive an input voltage; a capacitor including a first end connected to a first inductor and a ground terminal via a switch, the capacitor including a second end connected to a second inductor and the input node via a switch; a plurality of switches configured to set connections between the input node, the ground terminal, the first inductor, the second inductor, and the capacitor; and an output node connected to the first inductor and the second inductor, the output node configured to provide an output voltage to a load, and
wherein the method comprises: determining an operation mode based on the output voltage and the input voltage; and
controlling the plurality of switches according to the operation mode.
